(19) United States
(12) Patent Application Publication
(10) Pub. No.: US 2012/0285390 A1
(43) Pub. Date: Nov. 15, 2012

(54) POULTRY DRINKING SYSTEM

(76) Inventors: Oded Katz, D.N. Menashe (IL); Yonatan Bernat, D.N. Menashe (IL)

(21) Appl. No.: 13/558,632

(22) Filed: Jul. 26, 2012

Related U.S. Application Data
(63) Continuation-in-part of application No. PCT/IB2011/051077, filed on Mar. 15, 2011.

(30) Foreign Application Priority Data
Jan. 27, 2010 (GB) GB1001294.6

(51) Int. Cl. A01K 7/02; A01K 7/00

(52) U.S. Cl. 119/72

(57) ABSTRACT

A drinker system for delivering water to animals comprising: a central pressure regulator; drinker lines with drinker nozzles; pressure reduction valve devices providing an outlet pressure proportional to the pressure set by the central pressure regulator; each valve device comprising: a housing defining a relatively high pressure zone and a relatively low pressure zone; a relatively small area diaphragm in the relatively high pressure zone; a relatively large area diaphragm in the relatively low pressure zone, and rigidly connected to the small area diaphragm; a flow regulating valve through which liquid can flow from the relatively high pressure zone to the relatively low pressure zone; and an internal by-pass mechanism for allowing liquid to flow from the valve device inlet to the valve device outlet bypassing the flow regulating valve.

### CROSS REFERENCE TO RELATED APPLICATIONS

This application is a national stage application claiming priority from international application PCT/IB2011/051,177 entitled “Poultry drinker system”, filed 15 Mar. 2011 which claims priority from patent application GB 1001294.6, entitled “Poultry drinker system”, filed on 27 Jan. 2010.

### BACKGROUND OF THE INVENTION

Drinker systems for supplying drinking water or the like to poultry typically include several drinker lines, each line having a plurality of water dispensers (e.g. nozzles, nipples or the like). Relatively high pressure water from a common water source is delivered to one or more regulators that provide water to the drinker line at a low/reduced pressure.

It is believed that the drinker systems disclosed in U.S. Pat. No. 5,967,167 and U.S. Pat. No. 6,253,708 well describe the present state of the art.

On the one hand, it is advantageous to keep human interference to a minimum—i.e. provide for as much automatic control of the drinking process as possible to reduce labor and avoid disturbing the flock; while on the other hand, it is advantageous to avoid the use of electrical wires and such due to the corrosive atmosphere in poultry houses; as well as to avoid complicated systems which tend to be expensive.

It is also important to be able to change (control) the water pressure to the poultry in order to encourage proper consumption, especially in the case of growing chicks whose water requirements rapidly increase as they grow. In simpler system, changing the water pressure typically requires adjustment to each drinker line, i.e. each pressure regulator and/or pressure reduction device associated with each drinker line. Further, it is desirable to design for purging (flushing) of the drinker lines to flush residual material and the like from the lines, however, without undo complication to the system to avoid expensive design.

### SUMMARY OF THE INVENTION

The present invention relates to an apparatus or system designed to provide liquid to animals. As the system is particularly suited to providing water to poultry, it will, without limitation, be described in regard to that implementation.

In accordance with embodiments of the invention there is provided a system for delivering a liquid, such as water, to animals, such as poultry, the system comprising: a central pressure regulator for receiving liquid from a relatively high pressure liquid source; a plurality of drinker lines, each drinker line having a plurality of drinker nozzles; a plurality of pressure reduction valve devices providing an outlet pressure proportional to the pressure set by the central pressure regulator, the valve devices respectively associated with the plurality of drinker lines and downstream of said central pressure regulator, the valve devices having an inlet fed by piping and an outlet whereat relatively low pressure liquid is provided to the drinker lines; each of the pressure reduction valve devices comprising: a housing defining a relatively high pressure zone and a relatively low pressure zone; a relatively small area diaphragm in the relatively high pressure zone; a relatively large area diaphragm in the relatively low pressure zone and rigidly connected to the small area diaphragm, the relative areas of the diaphragms determining the inlet to outlet pressure ratio of the valve devices; a flow regulating valve through which liquid can flow from the relatively high pressure zone to the relatively low pressure zone when the regulating valve is open; and an internal by-pass mechanism for allowing liquid to flow from the valve device inlet to the valve device outlet bypassing the flow regulating valve.

In the specification and claims, the terms “liquid” and “water” may be used interchangeably without limitation specifically to water, rather any suitably flowing medium.

In accordance with some embodiments, the poultry drinker system further comprises a drinker line pressure indicator; in other embodiments the system comprises an electronic pressure controller for automatic adjustment of the central pressure regulator; in other embodiments, the pressure reduction valve devices of the system comprise a calibration (zeroing) mechanism; in other embodiments, the bypass mechanism comprises a bypass valve having separated channels for alternatively diverting liquid at the inlet of the valve device from the high pressure zone to the low pressure zone, which in particular embodiments, the bypass valve is adapted to be manually operated, whereas in other embodiments adapted to be electronically controlled.

Using the above-described system allows controlling the delivery of liquid to animals, by adjusting the central pressure regulator to control the pressure in the drinker lines.

It is a particular feature of the invention to provide a system wherein the valve devices provide a predictable pressure reduction between their inlet and outlet pressure for convenient and predictable pressure control to the drinker lines, those valve devices being controllable from the central pressure regulator. In preferred embodiments, such pressure control is accomplished by providing a constant proportional inlet/outlet pressure ratio by the pressure reduction valve; and in particular by using a pair of diaphragms having different effective areas, rather than only one large diaphragm and a spring or two different springs, which due to the spring constant(s), may provide a less than linear inlet-to-outlet pressure ratio.

It is another particular feature of the invention to provide a flushing mechanism that allows flushing of the drinker lines as well as key portions of the pressure reduction valve; in particular embodiments, wherein the flushing mechanism is integrated with the pressure reduction valve.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective view of an embodiment of a poultry drinker system of the present invention;

FIGS. 2A-2C are sectional views of a proportional pressure regulating/reduction valve device particularly adapted for use in the present drinker system, the device in: (a) the closed (no flow), non-flushing state; (b) the normal flow, non-flushing state; and (c) in the flushing state, respectively; and

FIG. 3 is a sectional view of a proportional pressure regulating/reduction valve device in accordance with a relatively simplified embodiment of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

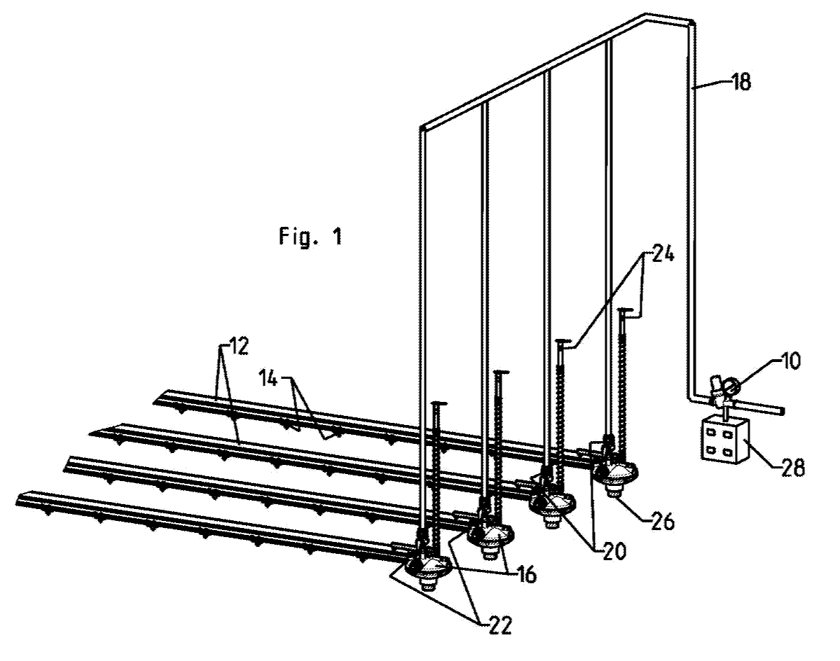

FIG. 1 shows a drinker system in accordance with embodiments of the invention for receiving water or other liquid from a relatively high pressure liquid/water source (not shown), for example at mains pressure, while providing the liquid at a relatively low pressure, to animals, such as poultry. The drinker system includes a central pressure regulator 10 for providing a first pressure reduction to the water from the water source; a plurality of drinker lines 12, each line having a plurality of drinker nozzles 14; and a plurality of pressure reduction valve devices 16, one such device associated with each drinker line, for providing the liquid at a relatively low pressure to the at least one drinker line.

Water flowing from central pressure regulator 10 to pressure reduction devices 16 is typically run through piping 18 preferably having a height well above the floor of the watering area in which the poultry are situated and even more so above the height of humans, for example, about 2.5 m in order to prevent the piping from disturbing the poultry and for ease of human movement in the poultry house if required. As a result, the minimum pressure at which water arrives to the pressure reduction devices 16 is equal to the head of the water or about 250 cm water column. Piping 18 leads to inlets 20 of the pressure reduction devices 16; and drinker lines 12 are fed by outlets 22 of the pressure reduction devices.

Also notable in FIG. 1 is a drinker line pressure indicator, for example, a transparent site glass or site tube 24 associated with each pressure reduction device 16 for measuring and displaying the outlet pressure, i.e. water pressure delivered to each drinker line 12; and a pressure zeroing knob 26 for initial calibration (setting/zeroing) of the pressure reduction devices' outlet pressure. In some embodiments, the system further includes an electronic pressure controller 28 for automatic adjustment of the central pressure regulator 10.

In practice, high pressure water arriving from the high pressure water source is regulated via central pressure regulator 10 to a relatively intermediate pressure, typically in the range of 0.25-3.0 bar. The water is distributed via piping 18 to each of the plurality of pressure reduction valve devices 16 where the water pressure is reduced again, in a manner proportional to the pressure set by central pressure regulator 10 (as will be explained in more detail below). The pressure of the water delivered to the drinker lines 12 (i.e. to the poultry) can therefore be controlled by controlling central pressure regulator 10. This is significant as it is important to maintain proper pressure, which changes as the poultry grows and due to other conditions, in order to positively affect the health and growth of the poultry, especially rapidly growing chicks, for example.

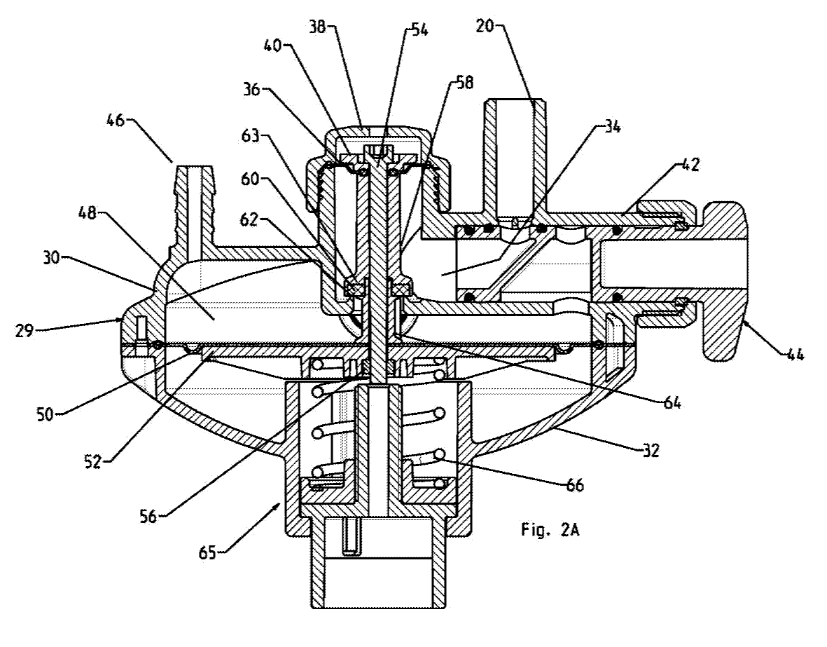

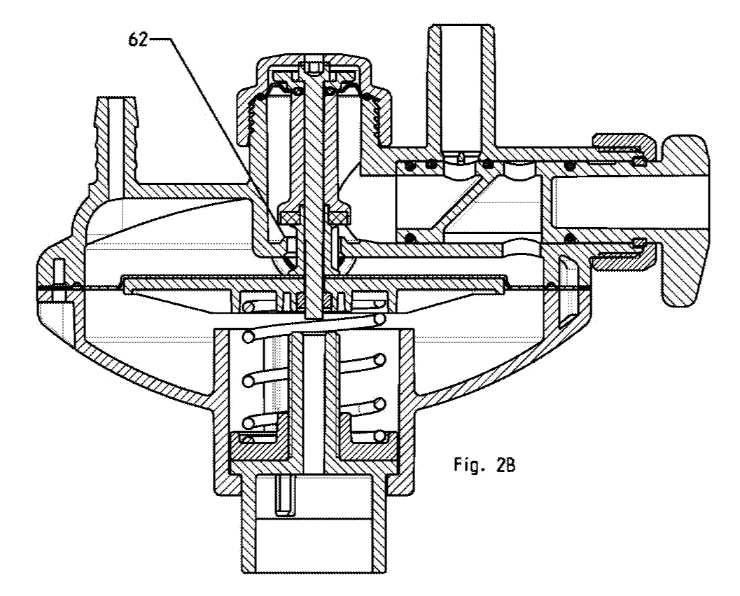

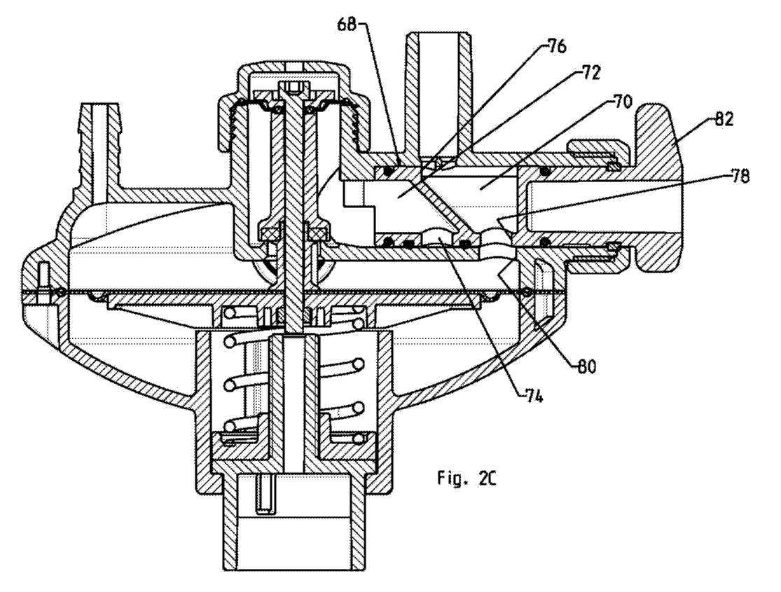

In FIGS. 2A-2C there is shown an embodiment of the pressure reduction devices 16 by way of sectional views thereof in various states of operation. The devices 16 include a housing 29 with an upper housing portion 30 and a lower housing portion 32, the upper housing portion defining a first relatively high pressure zone 34 (at a pressure regulated by central pressure regulator 10) which during drinking (normal flow) receives water via inlet 20. In high pressure zone 34 is a relatively small area diaphragm 36 fixed at its periphery between a cap 38 and upper housing portion 30 and supported by a relatively small area support plate 40. Upper housing portion 30 also defines a tubular by-pass or flushing valve receiving portion 42 for receiving an integrated internal by-pass or flushing valve 44 of the valve device 16.

Upper housing portion 30 also includes a pressure measurement connection or nipple 46 to which site tube 24 is connected. The site tube 24 communicates with a relatively low pressure zone 48 of the proportional pressure reducing valve device 16. Low pressure zone 48 is generally defined by upper housing portion 30 and a relatively large area diaphragm 50, which is supported by a relatively large area support plate 52. Small diaphragm 36 is operably connected to large diaphragm 50 via a rigid connector, for example bolt 54 and nut 56. Surrounding bolt 54 in high pressure zone 34 is a first rigid sleeve 58.

The ratio of the areas of the diaphragms 36 and 50 provide for a pressure reduction valve device outlet pressure that is proportional to the valve device's inlet pressure, i.e. the pressure set by the regulator 10. A typically pressure ratio is about 40:1. Thus, for example, controlling the central pressure regulator 10 in a range of 0.25-3.0 bar results in a drinker line pressure about 0.0065-0.075 bar (6.5-75.0 cm water column).

A first end of sleeve 58 interfaces with diaphragm 36 and a valve seal 60 is disposed within a second end of the sleeve. The valve seal 60 interfaces with a valve seat 62 when the valve device 16 is in the closed (no flow) state (FIG. 2A). The valve seal 60 and valve seat 62 form a regulating valve 63 of the pressure reduction valve device 16. A second rigid sleeve 64 surrounds the bolt 54 in low pressure zone 48.

Housed in lower housing portion 32 is a calibration mechanism 65 having a calibration or zeroing spring 66, which is adjustable by the pressure zeroing knob 26 (FIG. 1). The calibration mechanism 65 is used to affect/adjust the initial outlet pressure of the valve devices), which is sometimes not completely consistent from device to device due to minor tolerances in the components thereof. Typically a one-time setting/calibration (“zeroing”) is all that is required to coordinate the outlet pressure of the plurality of valve devices 16, which is verifiable by the site tubes 24.

FIG. 2A shows the pressure reduction valve device 16 in a closed (non-flow) state, which occurs when the pressure in the drinker line 12, or more specifically the pressure in low pressure zone 48, is not below the pressure in the high pressure zone 34 divided by the pressure reduction factor. The desired pressure of water fed to the drinker lines 12 (i.e. in the low pressure zone 48), is the pressure in the high pressure zone 34 divided by the ratio of areas of the large diaphragm 50 to the small diaphragm 36 (pressure reduction factor). Thus, the pressure pushing (down) on the large diaphragm 50, translated to its support plate 52, pulls (down) on bolt 54, to close the regulating valve 63, i.e. close seal 60 to seat 52.

FIG. 2B shows the pressure reduction valve device 16 in an open (normal-flow) state, which occurs when the pressure in the drinker line 12, or more specifically the pressure in low pressure zone 48, is below the pressure in the high pressure zone 34 divided by the pressure reduction factor, which occurs when the drinker nozzles 14 are opened (during drinking). Thus, the relatively high pressure in the high pressure zone 34 pushes (up) on its support plate 40, moving (raising) bolt 54, to open the regulating valve 63, i.e. open seal 60 from seat 52.

FIG. 2C shows the pressure reduction valve device 16 in a bypass (flushing/purging) state, which shall be described in conjunction with a description of details of integrated internal by-pass or flushing valve 44. Flushing valve 44 has an extension 68 extending into flushing valve receiving portion 42 and with a by-pass channel 70 and a normal flow channel 72, at the distal end thereof. Normal flow channel 72 has a channel inlet 74 which is aligned with valve device inlet 20 when the by-pass valve 44 of the valve device 16 is in the non-flushing state (FIGS. 2A and 2B); and not aligned with the valve device inlet 20 when in the flushing state (FIG. 2C). By-pass channel 70 has an opening 76 which is aligned with valve device inlet 20 when the by-pass valve 44 of the valve device 16 is in the flushing state (FIG. 2C); and not aligned with the valve device inlet 20 when in the non-flushing state (FIGS. 2A and 2B). By-pass channel 70 further has an outlet 78 which is aligned with a flushing aperture 80 of the upper housing portion 30 when in the flushing state (FIG. 2C).

In one exemplary alternative embodiment (not shown), the by-pass valve 44 is designed to be insertable and partially withdrawn (for example having an inward/outward screwing mechanism) in order to align apertures or channels with the valve device's inlet 20 to vary flow between a flushing and non-flushing state, mutatis mutandis.

By-pass valve has a manual operation knob 82 for convenient actuation of the flushing state, however, in some embodiments (not shown), the valve device 16 includes an automatic flush-activation mechanism, for example, including a small motor for rotating the by-pass valve 44 between the flushing and non-flushing states (or other such mechanisms, for example wherein the by-pass valve is moved inward and outward to provide flow passage switching between a flushing and non-flushing mode). Another example of an automatic flushing mechanism (by-pass mechanism) is an electrically operated valve (not shown) having an inlet connected externally at or near inlet 20 and having an outlet connected to the flushing valve receiving portion 42 wherein the receiving portion 42 is hydraulically separated (e.g. by an internal wall) from the inlet 20 so as to deliver the flushing liquid directly to flushing aperture 80 of the upper housing portion 30.

Thus, there is provided a cost effective and uncomplicated drinker system and pressure reduction valve device therefor. The pressure in the drinker lines 12 is conveniently controllable by controlling the pressure at the central pressure regulator 10.

Further, the drinker lines 12 and the low pressure zone 48 of the pressure reduction valve device 16 are conveniently flushable without need for expensive or complicated auxiliary systems. While the by-pass mechanism described in embodiments of the present drinker system and valve device therefor, does not rinse the high pressure zone 34, this is typically not a practical concern.

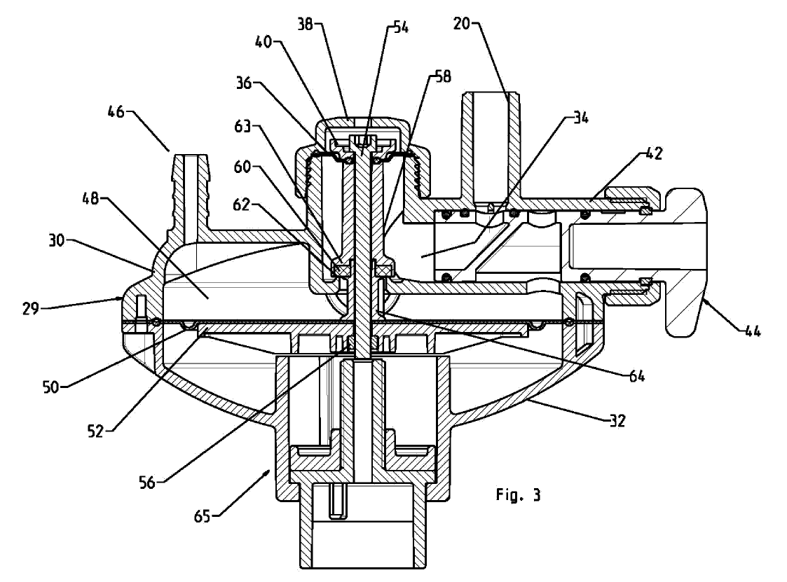

FIG. 3 depicts an embodiment of the present invention wherein there is no zeroing mechanism and thus no zeroing spring 66 or zeroing knob 26.

Operation: the poultry drinker system is operated by adjusting a central pressure regulator, such as regulator 10, to control the pressure in the drinker lines 12, which can include periodically operating an integrated flushing/by-pass mechanism, for example, constituted by integrated internal by-pass or flushing valve 44 integrated into each of the plurality of pressure reduction valve devices 16, in order to flush the drinker lines.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A drinker system for delivering liquid to animals comprising:
a central pressure regulator for receiving liquid from a relatively high pressure water source;
a plurality of drinker lines, each drinker line having a plurality of drinker nozzles;
a plurality of pressure reduction valve devices providing an outlet pressure proportional to the pressure set by the central pressure regulator, the valve devices respectively associated with the plurality of drinker lines and downstream of said central pressure regulator, the valve devices having an inlet fed by piping and an outlet whereat relatively low pressure liquid is provided to the drinker lines;
each of the pressure reduction valve devices comprising:
a housing defining a relatively high pressure zone and a relatively low pressure zone;
a relatively small area diaphragm in the relatively high pressure zone;
a relatively large area diaphragm in the relatively low pressure zone and rigidly connected to the relatively small area diaphragm, the relative areas of the diaphragms determining the inlet to outlet pressure ratio of the valve devices;
a flow regulating valve through which liquid can flow from the relatively high pressure zone to the relatively low pressure zone when the regulating valve is open; and
an internal by-pass mechanism for allowing liquid to flow from the valve device inlet to the valve device outlet bypassing the flow regulating valve, whereby the central pressure regulator can be set to thereby control the outlet pressure of the plurality of drinker lines by affecting the inlet pressure to each of the plurality of pressure reduction valve devices.

2. The system according to claim 1, further comprising a drinker line pressure indicator.

3. The system according to claim 1, further comprising an electronic pressure controller for automatic adjustment of the central pressure regulator.

4. The system according to claim 1, wherein the pressure reduction valve devices comprise a zeroing mechanism.

5. The system according to claim 1, wherein the bypass mechanism comprises a bypass valve having separated channels for alternatively diverting liquid at the inlet of the valve device from the high pressure zone to the low pressure zone.

6. The system according to claim 5, wherein the bypass valve is adapted to be manually operated.

7. The system according to claim 5, wherein the bypass valve is adapted to be electronically controlled.
